(19) United States
(12) Patent Application Publication
(10) Pub. No.: US 2005/0279060 A1
(43) Pub. Date: Dec. 22, 2005

(54) Dust filter bag and an associated adapter plate

(75) Inventors: Uwe Schmierer, Unternbibert-Rugland (DE); Herbert Krehan, Furth (DE); Jurgen Rammig, Neuendettelsau (DE); Gunther Eigenwillig, Nurnberg (DE)

Correspondence Address: BROWDY AND NEIMARK, P.L.L.C.;624 NINTH STREET, NW, SUITE 300, WASHINGTON, DC, 20001-5303, US

(73) Assignee: BRANOfilter GmbH, Dietenhofen (DE)

(21) Appl. No.: 11/155,768

(22) Filed: Jun. 20, 2005

(30) Foreign Application Priority Data
Jun. 18, 2004 (DE) 10 2004 030 346.0

(51) Int. Cl. B01D 46/02

(52) U.S. Cl. 55/374; 55/376

(57) ABSTRACT

A dust filter bag for vacuum cleaning devices has a bag wall consisting of air permeable filter material, which has an entry opening. Externally on the bag wall and adjacent to the entry opening there is a base means with a base plate or base foil attached to the bag wall, such plate of foil having a passage flow opening extending through it arranged flush with the entry opening and an attachment means for the releasable attachment of an adapter plate, which in the secured state is seated on the outer side facing away from the bag wall.

### BACKGROUND OF THE INVENTION

The invention relates to a dust filter bag for vacuum cleaning equipment, comprising a bag wall consisting of air permeable filter material, such wall having an entry opening.

### STATE OF THE ART

In the case of vacuum cleaning devices filter bags are employed for collecting the aspirated up dust. For this purpose a blower is utilized to produce a suction air flow, which draws the dust into a suction hose or the like and thence through the entry opening into the filter bag. The dust contained in the aspirated air is retained by the bag wall. The air current freed of the dust passes through the bag wall and then escapes into the surroundings. When the filter bag is full it is removed and may be discarded. Then a new filter bag is placed in the vacuum cleaning device.

Securing the filter bag of the vacuum cleaning device is generally performed using a connection member mounted externally on the bag wall adjacent to the entry opening, such member being brought into engagement with a holding means on the device. The commercially available vacuum cleaners of various manufacturers however have different holding means so that a corresponding number of filter bag types must be available, which respectively possess a different connection member. This lead to undue complications.

### SHORT SUMMARY OF THE INVENTION

One object of the invention is therefore to reduce the variety of bags.

In order to achieve these and/or other objects appearing from the present specification, claims and drawings, the present invention provides a dust filter bag for vacuum cleaning devices, having a bag wall of air permeable filter material, which has an entry opening, a base means being arranged externally on the bag wall adjacent to the entry opening and having a base plate or base foil, attached to the bag wall and having a passage flow opening extending through it which is arranged flush with the entry opening, and an attachment means serving for detachable attachment of an adapter plate, which in the attached state is seated on the outer side, facing away from the bag wall, of the base means.

The dust filter bag in accordance with the invention may be utilized for vacuum cleaning devices with different holding means, since the adaptation to the respective holding means is due to the adapter plate. Accordingly it is merely necessary to have adapter plates adapted to the different holding means which are all able to be detachably secured to one and the same filter bag base means.

In this respect it is sufficient if the respective user is provided with one adapter plate suitable for his device, and which he may use for all filter bags later purchased by him. Before the insertion of the respective filter bag in the vacuum cleaning device he merely has to fit the adapter plate on the base means of the filter bag. On removal of a full filter bag he will then take off the adapter plate so that he may reuse it for the next filter bag.

In the state mounted on the base means the adapter plate's air passage hole is accordingly flush with the said passage flow opening the adapter plate having a holding means, cooperating with the attachment means for the detachable connection of the adapter plate to the base means.

The manufacture, stockholding and distribution of the filter bags is consequently substantially simplified and cheapened.

Further advantageous developments of the invention are defined in the claims.

Further advantageous developments and convenient forms of the invention will be understood from the following detailed descriptive disclosure of two embodiments thereof in conjunction with the accompanying drawings.

### LIST OF THE SEVERAL VIEWS OF THE FIGURES

FIG. 1 shows a dust filter bag in accordance with the invention in plan view, two further identical filter bags being indicated in chained lines, which are able to be torn off for use.

FIG. 2 shows a wound up roll of filter bags able to be separated by tearing apart in a diagrammatic side view.

FIG. 3 shows the portion, comprising the base means, of the filter bag in accordance with FIG. 1 in a cross section taken on the section line III-III on a greater scale.

FIG. 4 shows an adapter plate detachably secured to the base means of the filter bag in accordance with FIGS. 1 and 3 in a separate plan view.

FIG. 5 shows the portion, comprising the base means, of the filter bag in accordance with FIGS. 1 and 3 in a plan view with the adapter plate secured on the base means.

FIG. 6 shows the arrangement in accordance with FIG. 5 in a section similar to the section of FIG. 3 but with a partly offset section line VI-VI.

FIG. 7 shows a second embodiment of the dust filter bag in accordance with the invention in plan view to indicate only the portion of the filter bag comprising the base means.

FIG. 8 shows the arrangement according to FIG. 7 with the covering foil wit the burr fastener elements, the closure slide being removed or respectively in a stage of production before same are attached.

FIG. 9 shows the arrangement as shown in FIG. 7, the closure slide and the burr fastener elements being removed or not yet attached during production.

FIG. 10 shows the arrangement as shown in FIG. 7, the burr fastener elements being removed or not yet attached during production.

FIG. 11 shows the filter bag in accordance with FIG. 7 in plan view with the adapter plate mounted on the base means.

FIG. 12 shows the adapter plate employed in the embodiment in accordance with FIGS. 7 through 11 in a view corresponding to FIG. 11.

FIG. 13 shows the arrangement in accordance with FIG. 11 in a diagrammatic side view indicated by the arrow XIII, the base foil, the covering foil and the closure slide being illustrated with an exaggerated thickness in comparison with the adapter plate.

### DETAILED ACCOUNT OF WORKING EMBODIMENTS OF THE INVENTION

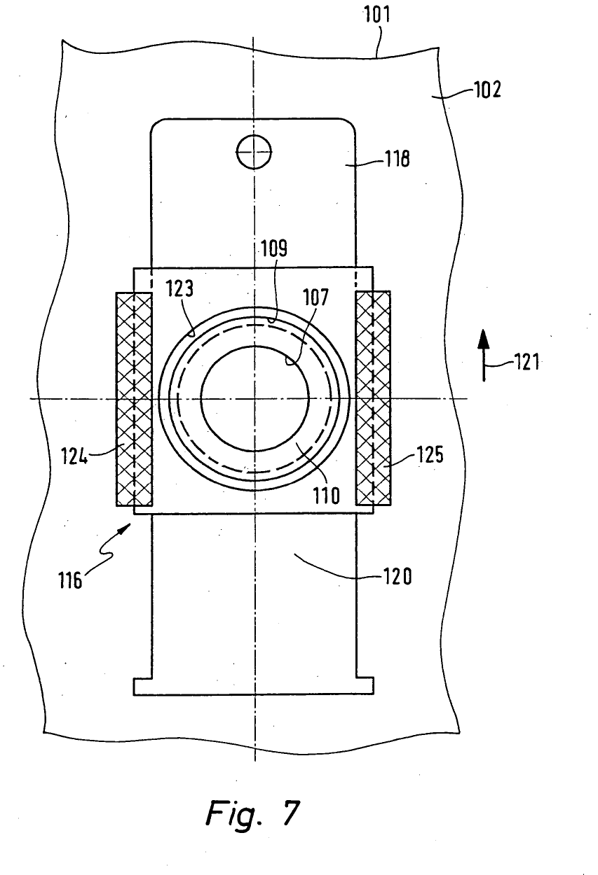

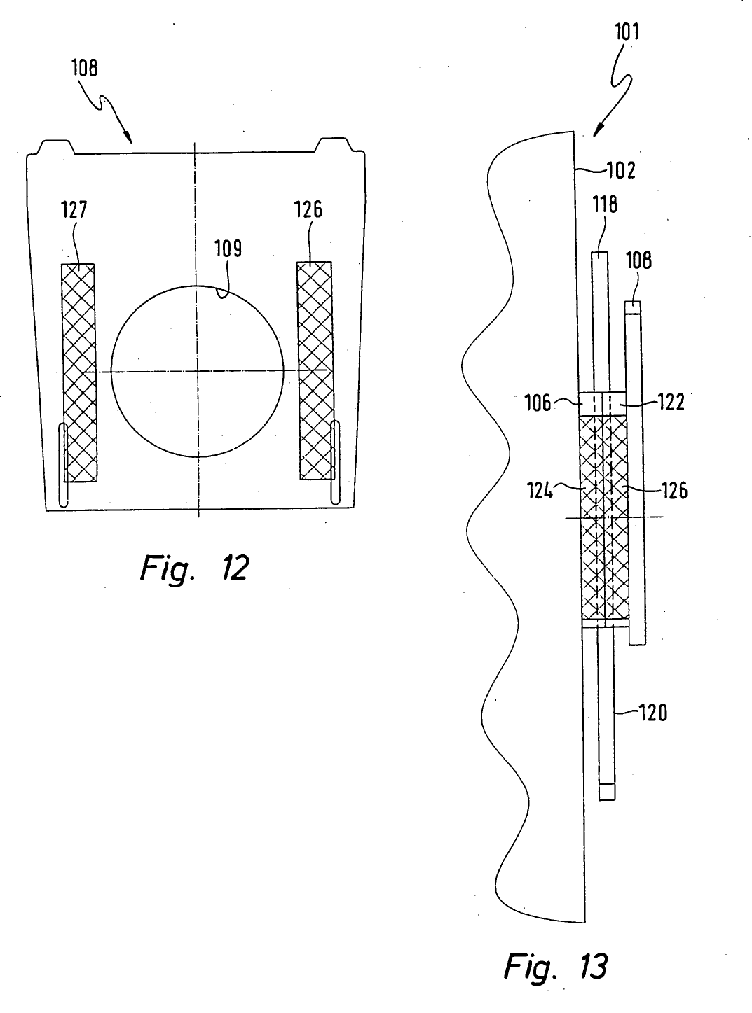

The dust filter bags 1; and 101 illustrated in the figures have an at least substantially rectangular peripheral form. This applies also for the filter bag 101 not completely depicted in FIGS. 7 through 13.

The bag wall constituted by a front wall 2; and 102 and a rear wall 3 consists of air permeable material and has an entry opening 4, 104 arranged in the front wall 2; and 102 by way of which arriving dust containing air passes into the interior 5 of the bag. The type of filter material and whether the bag wall single- or multi-layered is unimportant in the present context with the exception that the filter material in a preferred embodiment should consist of thermoplastic material at least adjacent to the entry opening 4; and 104 and accordingly may be welded by ultrasonic energy.

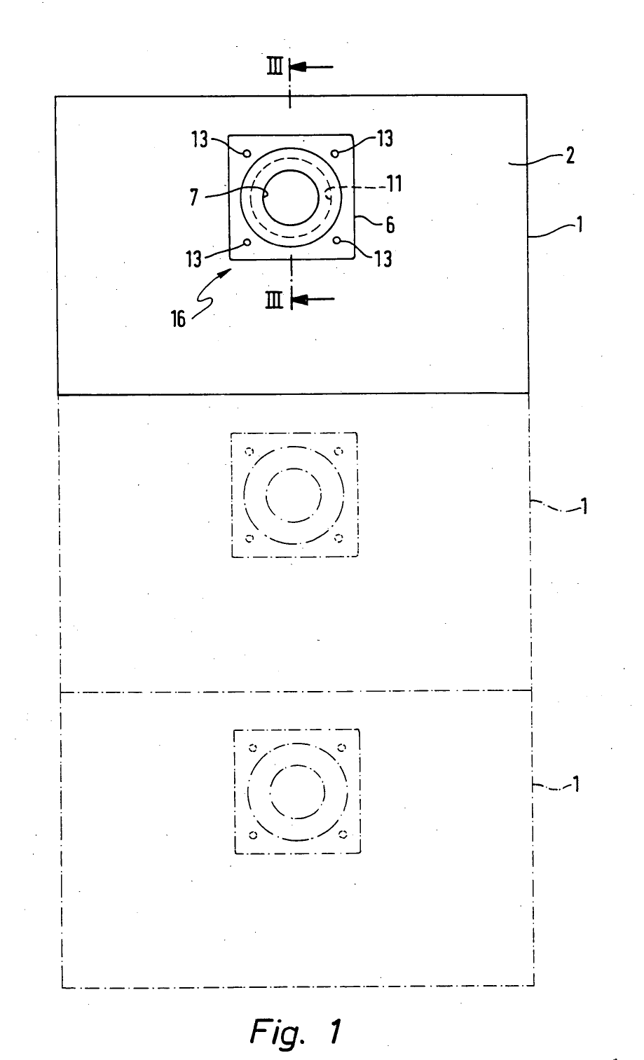

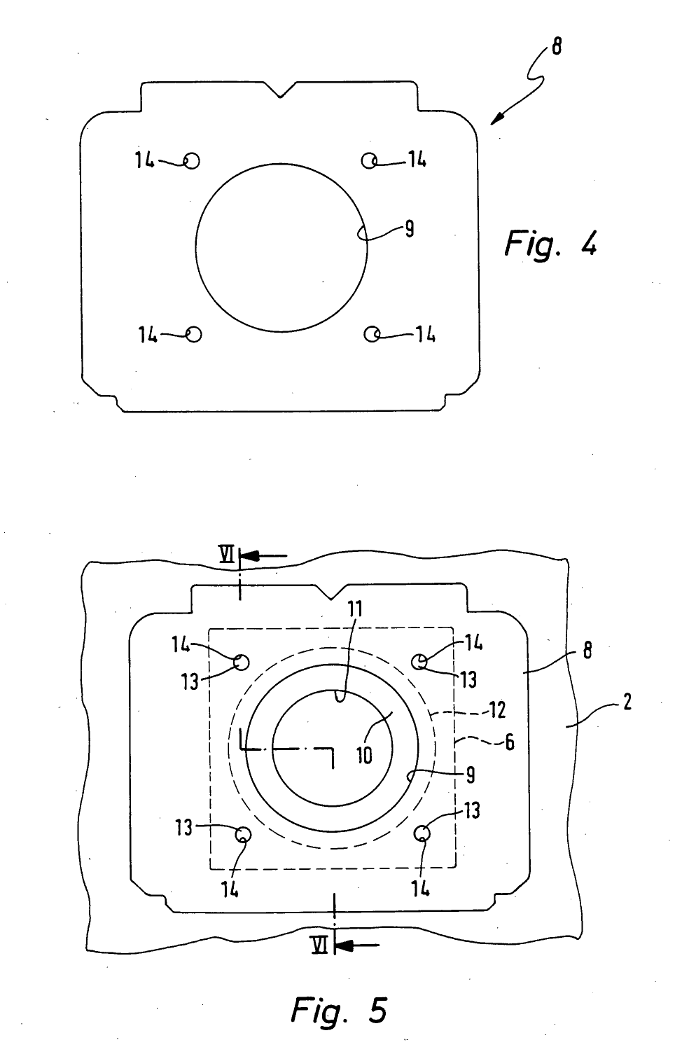

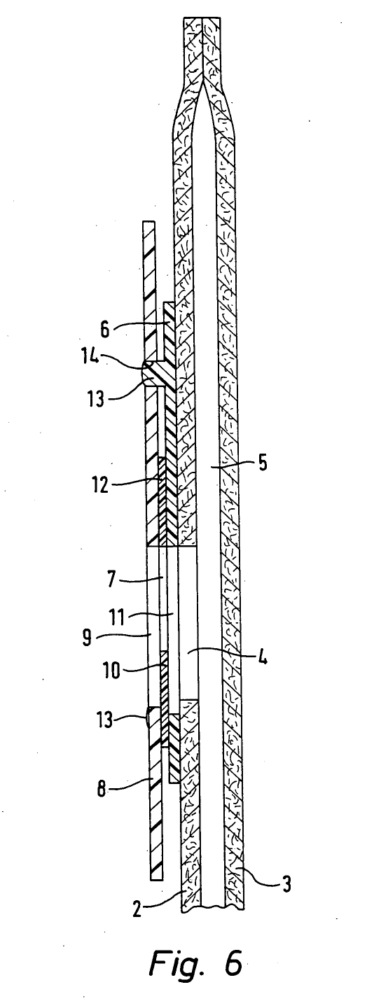

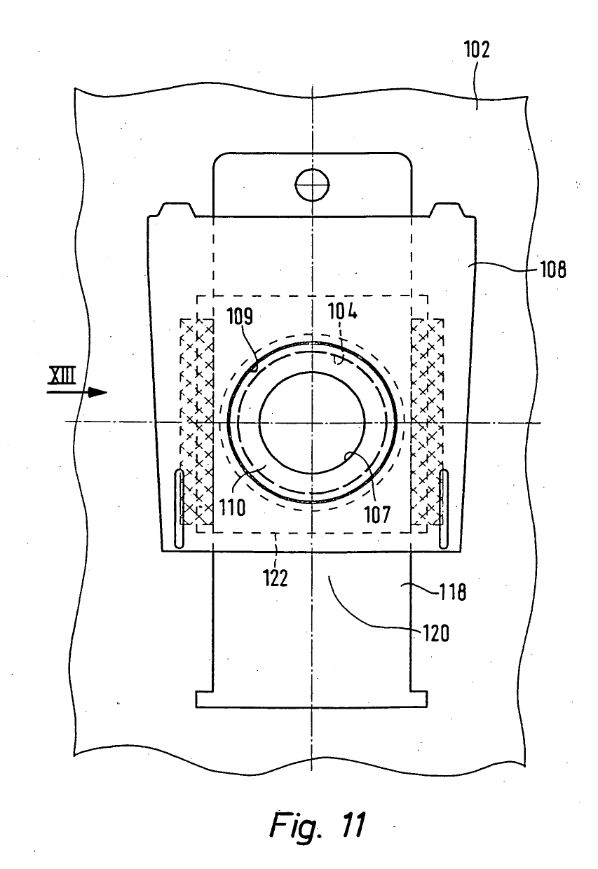

Adjacent to the entry opening 4; and 104 a base means 16; and 116 is attached externally on the front wall 2; and 102, such base means 16; and 116 having a base plate 6 (working example of FIGS. 1 through 6) or a base foil 106 (example in accordance with FIGS. 7 through 13) attached to the bag wall, same having an air passage flow opening 7; and 107 extending through it flush with the entry opening 4; and 104. On the outer side, facing away from the front wall 2; and 102 of the bag wall, of the base means 16; and 116 an adapter plate 8; and 108 may be detachably secured so that in the attached state the arrangement indicated in FIGS. 5 and 6 and, respectively, 11 and 13 results. The adapter plate 8; and 108 has an air passage hole 9; 109 which is flush with the passage flow opening 7; 107, in the attached state, in the base plate 6 or respectively the base foil 106. As more particularly shown in FIG. 5 or respectively FIG. 11, the adapter plate 8 and 108 is larger in area than the base plate 6 and respectively the base foil 106 and in the secured state extends past the base plate 6 or the base foil 106 at the edge.

The base plate 6 and respectively the base foil 106 may essentially have rectangular outlines, as is represented in FIGS. 1 and 5 or FIG. 8, respectively. This could however in principle be different.

The base means 16; and 116 with the base plate 6 or, respectively, the base foil 106 is a fixed component of the filter bag 1; and 101. The adapter plate 8; and 108 is on the contrary a separate part.

The filter bag 1; and 101 is for use inserted in a vacuum cleaning device. For securing the filter bag in the device the latter has a corresponding holding means, which may vary from one device to another. The adapter plate 8; and 108, which is in use and detachably secured to the base means of the dust filter bag 1; and 101 engages the device's holding means and accordingly holds the filter bag in the vacuum cleaning device. For all possible device types the same filter bags 1; and 101 may be employed. It is only necessary for an adapter plate 8; and 108 suiting the respective device type to be to hand, which is fitted before the insertion of the filter bag 1; and 101.

If the filter bag is full, it is removed from the vacuum cleaning device and may be discarded. Previous to this however the adapter plate 8; and 108 is removed so that it is again available for the next filter bag.

In the condition inserted into the vacuum cleaning device a connection spigot on the device fits into the air passage hole 9; and 109 in the adapter plate 8; and 108 and the passage flow opening 7; and 107 in the base plate 6 or respectively the base foil 106 so that the aspirated dust laden air passes through the connection spigot into the interior 5 of the bag. The air current passes through the bag wall from the inside to the outside so that the bag wall retains the dust or other dirt in the interior of the bag.

In order to prevent exit of dust around the connection spigot, the base means 16; and 116 has a flexible, foil-like, thin sealing ring 10; and 110, which surrounds the passage flow opening 7; and 107. On insertion of the connection spigot same abuts the sealing ring 10; and 110 so that the sealing ring 10; and 110 is tucked round toward the interior of the bag and rests snugly against the outer periphery of the connection spigot.

In the working embodiment illustrated in FIGS. 1 through 6 base plate 6 possesses a plate opening 11 arranged flush with the passage flow opening 7 in the sealing ring 10, such plate opening 11 being larger in diameter than the passage flow opening 7. Furthermore, the sealing ring 10 is constituted by a sealing diaphragm 12 or membrane, which is larger in area than the plate opening 11.

The provision is preferably such that the sealing diaphragm 12 is mounted on the outer side of the base plate 6. This ensures that the portion in the sealing diaphragm 12, which lies radially outside the part forming the sealing ring 10, acts as an additional seal, when the adapter plate 8 is in place, between the base plate 6 and the adapter plate 8.

The sealing ring could however also be arranged at a different position, for example more particularly between the front wall 2 and the base plate 6.

In the working embodiment illustrated in FIGS. 7 through 13 instead of the base plate 6 there is the base foil 106. In this case the sealing ring 110 is constituted by an annular portion of the base foil 106 surrounding the passage flow opening 107.

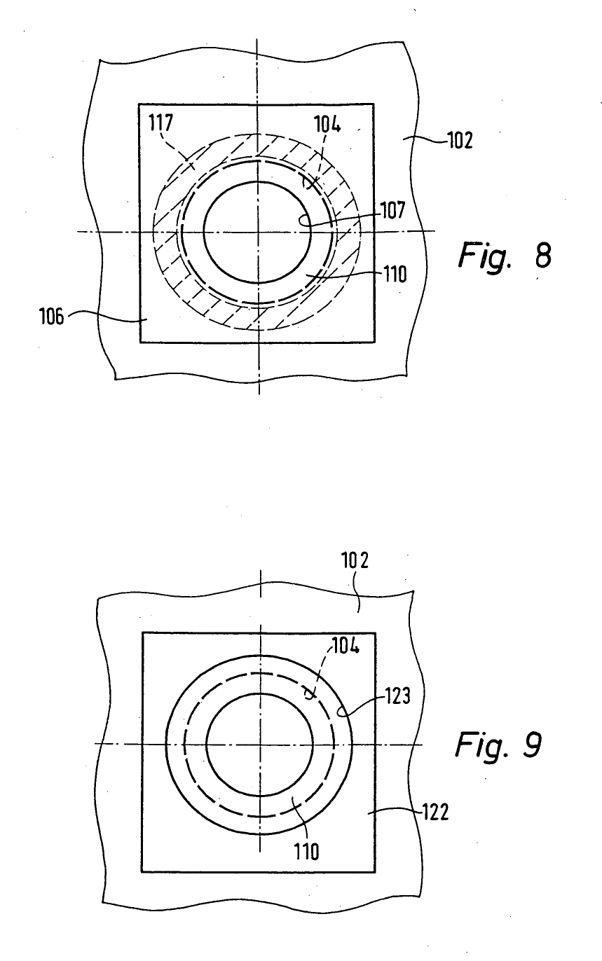

The base plate 6 or, respectively, the base foil 106 may be secured to the front wall 2; and 102 in different fashions. Such attachment may be by bonding or conveniently by a design such that at least at their contacting faces they consist of materials able to be welded ultrasonically, i. e. thermoplastic synthetic resin, and are connected together by a surrounding ultrasonic weldment. As shown in FIG. 8 the weld seam 117 connecting the base foil 106 with the front wall 102 is indicated in chained lines.

The sealing diaphragm 12 may also consist of a material (a thermoplastic one) able to be welded ultrasonically and may be connected by an ultrasonic weldment with the base plate 6 or, if the sealing diaphragm is arranged between the base plate 6 and the front wall 2, connected by an ultrasonic weld connected on the one hand with the base plate 6 and on the other hand with the front wall 2. In the latter case, not illustrated, the base plate is therefore connected with the front wall by way of the sealing diaphragm.

The ultrasonic weldments, with which in the case of the embodiment of FIGS. 1 through 6 the sealing diaphragm 12, the base plate 6 and the front wall 2 are joined together, may be applied by simultaneous welding in a single working step.

In order to prevent dust escaping, on removal of a full filter bag, through the passage flow opening into the surroundings, it is possible—as in the case of the working embodiment in accordance with FIGS. 7 through 13—the base means 116 to have a closure slide 118, which is able to be shifted between an open position (not illustrated) uncovering the passage flow opening 107 and a closing position closing the passage flow opening 107. The closure slide 118 has a closure slide opening 119 flush with the passage flow opening 107 and adjoining same a closure portion 120 which is closed and does not have an opening. If the diaphragm 118 is drawn out of its open position into the closing direction 121, the closure portion 120 will move over the passage flow opening 107.

The closure slide 118 is arranged to be linearly slid while guided by the base means 116. The closure slide 118 is furthermore preferably constituted by a flexible, foil-like thin closure slide band or tape.

To hold and guide the closure slide 118 the base means 116, in addition to the base foil 106, has a covering foil 112, which has a hole aligned or flush with the passage flow opening 107 and larger in diameter. The covering foil 122 is arranged above the base foil 106 in a direction away from the bag's front wall 102. On either side of the closure slide 118 the covering foil 122 connected with the base foil 106 along a strip so that lateral guiding of the closure slide 118, which extends at its two ends out of the slot between the two foils 106 and 122, in and opposite to the direction 121 takes place.

Instead of the base foil the covering foil could also be connected, to the side of the base foil, with the front bag wall 102.

In principle the covering foil could also be a covering plate. In this case it should however be flexible.

The covering foil 122 or, respectively, the covering plate also comprise ultrasonically welded plastic material and is welded to the base foil 106 to the side adjacent to the closure slide 118.

The covering foil 122 or, respectively, the covering plate may form the outer side of the base means.

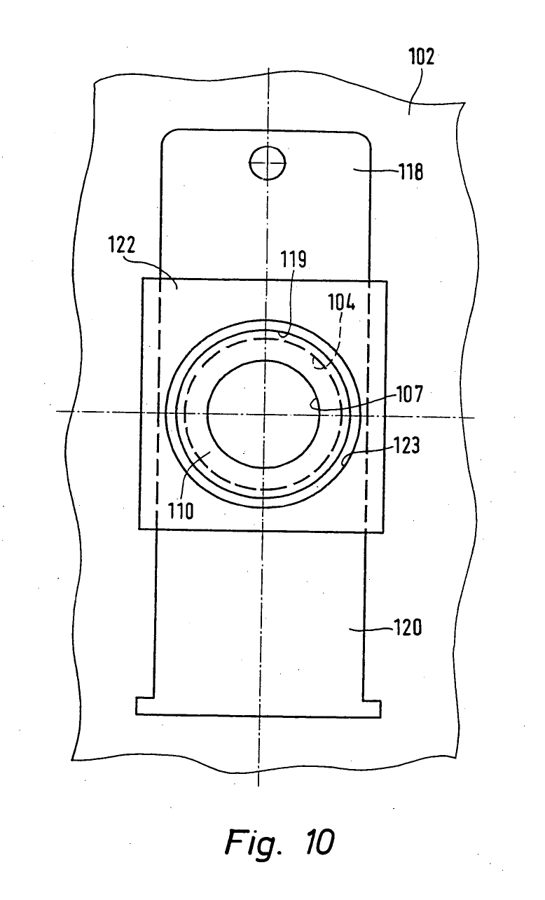

In FIG. 8 merely the base foil 106 is secured to the front bag wall 102. As shown in FIG. 9 the covering foil 122 is applied to the base foil 106. FIG. 10 shows the same arrangement as in FIG. 9, but however with the closure slide 118 inserted.

The base means 16 of the working embodiment in accordance with FIGS. 1 and 6 could be complemented by having a corresponding closure slide, as for example by designing the base plate 6 in two parts with two plate layers arranged one on top of the other and a closure slide arranged between them or by having a covering plate on the base plate 6 or having a covering foil with a closure slide sandwiched between them.

The adapter plate 8; and 108 is, as mentioned, able to be detachably secured to the base means 116; and 116. For this purpose the base means 16; and 116 has an attachment means on its outer side facing away from the bag wall. This attachment means may be designed in different ways. One possibility, adopted in the working example in accordance with FIGS. 1 through 6, is for the attachment means to be constituted by a plug means so that a plug connection can be produced with the adapter plate 8. This plug means comprises a plug pin 13 in the working embodiment illustrated. In this respect four plug pins 13 could be present. As will appear from the drawing such plug pins 13 are distributed arranged over the periphery and may be respectively placed in respective corner portions of the base plate 6.

In the working embodiment illustrated in FIGS. 7 through 13 the attachment means is formed by one or more burr fasteners elements 124 and 125.

In the case illustrated two strip-like burr fastener elements 124 and 125 are present, which are arranged on either side 123 in the covering foil 122 and/or adjacent to the covering foil.

The respective adapter plate 8; and 108 possesses a holding means associated with the attachment means of the base plate 6; and 106 to cooperate with same.

In the case of the working example in accordance with FIGS. 1 through 7 the holding means is, in accordance with the features of the base plate 6, preferably constituted by the plug adaptations, cooperating with the base plate 6. Here in connection with the pins .13 arranged on the base plate 6 such plugging adaptations may be retaining holes 14 formed in the adapter plate 8, which are arranged with a distribution corresponding to the pins 13.

For the attachment of the adapter plate 8 on the base plate the adapter plate 8 is placed so that its retaining holes 14 fit over the pins 13 on the base plate 6. Owing to having suitable size of their diameter the pins 13 may be seated with a force fit in the retaining holes 14 so that the adapter plate 6 is held in place firmly for use but can still be removed by hand.

Furthermore, a releasable catch could be utilized to hold the pins in place.

It will be clear that the arrangement may also be reversed so that the pins are arranged on the adapter plate and the holes in the base plate. In this case the pin receiving holes as the plug means arranged on the base plate, corresponding to the retaining holes 14 and the plugging adaptations arranged in the adapter plate would have retaining pins corresponding to the pin 13.

It would also be possible to have a hybrid arrangement, in the case of which both pins and also holes are provided on the base plate and the adapter plate, each pin fitting into a hole provided in the respectively other plate or board.

In the case of the working example illustrated in FIGS. 7 through 13 the holding means is formed by at least one burr fastener members 126 and 127 cooperating with the at least one burr fastener element 124 and 127. Accordingly in the case of the adapter plate 108 there is a respective strip-like burr fastener member on either side of the air passage hole 109. On shoving the adapter plate 108 against the base means 116, the burr fastening elements 124 and 125 and the burr fastener members 126 and 127 are detachably secured together.

In every case, that is to say irrespectively of whether it is attached by means of an ultrasonic weld on the front wall 2 or not, the base plate is preferably manufactured of plastic. In this case the attachment means, i. e. in the working embodiment the pins 13 may be molded integrally on the base plate 6.

In the case of the other working embodiment the base foil 106 as well as the covering foil 122 preferably also consist of plastic.

Moreover, the adapter plate 8; and 108 is preferably also manufactured of plastic. There may be a provision such that the holding means, i. e. in the case of the FIGS. 1 through 6 the retaining holes 14, the retaining holes 14 may be produced by integral molding in the adapter plate 14.

Dust filter bags are conventionally sold lying side by side in cartons.

The dust filter bags 1; and 101 in accordance with the invention may be packaged and sold in convenient numbers in boxes. Since however in lieu of the normal member it only has the base means 16; and 116, a different sales configuration is possible in which the bags are produced as a continuous roll to be separately torn off, such filter bag rolls constituting the sold items or units.

In addition to the filter bag 1 illustrated in full lines two further identical filter bags 1 are illustrated in chained lines in FIG. 1. These filter bags constitute a chain and may be torn off separately. It will be clear that the chain may be of any desired length, that is to say composed of any desired number of filter bags.

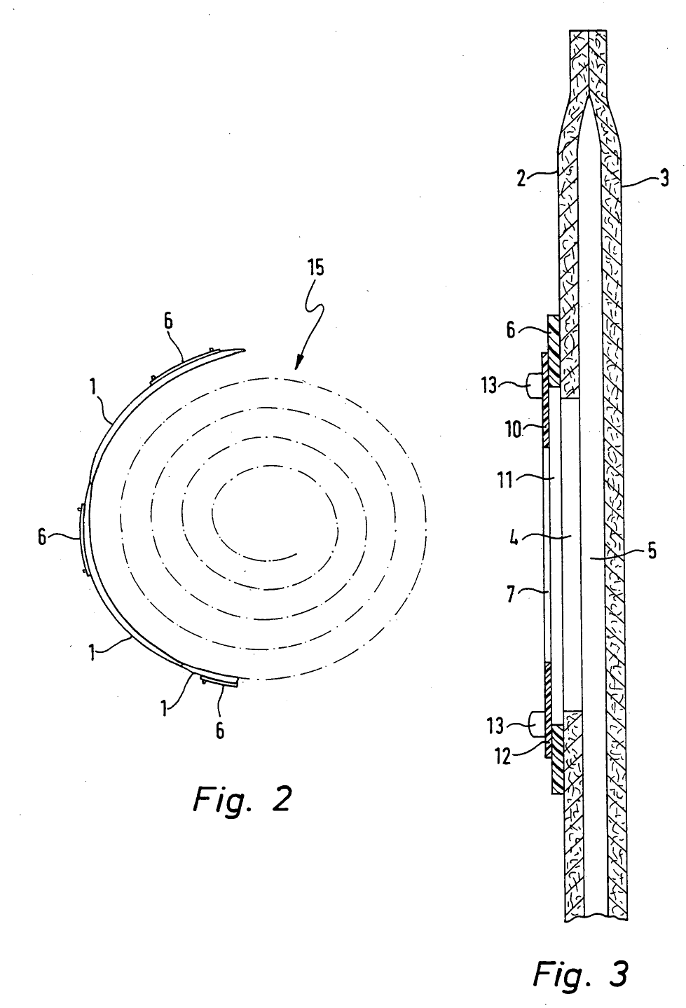

FIG. 2 shows a filter bag roll 15 made up of chained filter bags 1, only the outer filter bags being represented in full lines and the remaining filter bags being indicated by a chained line. Such filter bag rolls 15 may be produced substantially more cheaply and packaged in a more compact form, for example in a plastic foil.

It will be clear that the filter bags 101 as well can be produced in a chain which is wound up and which the bags may be torn off from. Therefore FIG. 2 also applies, apart from the different base means of the filter bags 101, for the embodiment in accordance with FIGS. 7 through 13.

In this connection it is appropriate for the base means 16; and 116 to flexible in form so that it can adapt itself to the round shape of the filter bag roll 15. In the case of plastic it is a question of a suitably flexible plastic material. In the case of the working example of FIGS. 7 through 13 the base foil 106 and/or covering foil 122 and/or the closure slide 118 could consist of paper or a paper-like material too.

1. A dust filter bag for vacuum cleaning equipment, comprising a bag wall consisting of air permeable filter material, which has an entry opening, a base means being arranged externally on the bag wall adjacent to the entry opening and having a base plate or base foil, attached to the bag wall and having a passage flow opening extending through it, which is arranged flush with the entry opening, and an attachment means serving for detachable attachment of an adapter plate, which in the attached state is seated on the outer side, facing away from the bag wall, of the base means.

2. The dust filter bag as set forth in claim 1, wherein the attachment means is constituted by plug means to produce a releasable plug connection with the adapter plate.

3. The dust filter bag as set forth in claim 2, wherein the plug means comprises insertable pins for releasable insertion in retaining holes in the adapter plate.

4. The dust filter bag as set forth in claim 2, wherein the plug means comprises receiving holes for the releasable insertion of retaining pins on the adapter plate.

5. The dust filter bag as set forth in claim 1, wherein the attachment means is molded integrally on the base plate or the base foil.

6. The dust filter bag as set forth in claim 1, wherein the attachment means includes one or more burr fastener elements for cooperation with one or more burr fastener members arranged on the adapter plate.

7. The dust filter bag as set forth in claim 1, wherein the base plate or the base foil consists of plastic.

8. The dust filter bag as set forth in claim 1, wherein the bag wall and the base plate or the base foil at least at their mutually contacting faces are made of materials able to be ultrasonically welded and are joined together by an ultrasonic weldment.

9. The dust filter bag as set forth in claim 1, wherein the base means defines a flexible, foil-like thin sealing ring which surrounds the passage flow opening.

10. The dust filter bag as set forth in claim 9, wherein the sealing ring is arranged on the base plate or between the bag wall and the base plate, the base plate having an air passage flow opening therein which is flush with the passage flow opening and whose diameter is larger than the diameter of the passage flow opening.

11. The dust filter bag as set forth in claim 10, wherein the sealing ring is formed by a sealing diaphragm whose area is larger than that of the base plate air passage flow opening.

12. The dust filter bag as set forth in claim 11, wherein the sealing diaphragm comprises ultrasonically weldable material and is connected with the base plate by an ultrasonic weldment or the sealing diaphragm is arranged between the base plate and the bag wall and connected by an ultrasonic weldment on the one hand with the base plate and on the other hand with the bag wall.

13. The dust filter bag as set forth in claim 11, wherein the sealing diaphragm is mounted on the outer side of the base plate.

14. The dust filter bag as set forth in claim 9, wherein the sealing ring is formed by the annular portion, surrounding the passage flow opening, of the base foil.

15. The dust filter bag as set forth in claim 14, wherein the base means has a closure slide able to be shifted between an open position clear of the passage flow opening and a closed position closing the passage flow opening.

16. The dust filter bag as set forth in claim 15, wherein the closure slide is guided on the base means for linear sliding motion.

17. The dust filter bag as set forth in claim 16, wherein the closure slide is constituted by a flexible, foil-like thin band or tape.

18. The dust filter bag as set forth in claim 15, wherein the closure slide is arranged in a sliding fashion between the base plate facing the bag wall or the base foil, and in a direction away from the bag wall is adapted to slide above the base plate or base foil a covering plate or covering foil is connected on either side of the closure slide with the base plate or base foil and/or with the bag wall.

19. The dust filter bag as set forth in claim 18, wherein the covering plate or the covering foil constitutes the outer side of the base means.

20. The dust filter bag as set forth in claim 1, constituting a component of a filter bag roll, which comprises a plurality of wound dust filter bags adapted to be severally torn off the roll.

21. The dust filter bag as set forth in claim 20, wherein the base means is flexible.

22. An adapter plate associated with a dust filter bag as set forth in claim 1, wherein such adapter plate has an air flow hole flush with the passage flow opening, in the state attached to the base means, and a holding means cooperating with the attachment means of the base means for releaseably attaching of the adapter plate to the base means.

23. The adapter plate as set forth in claim 22, wherein the holding means is constituted by plugging adaptations cooperating with the plugging means on the base means for the production a detachably plugged connection with the base means.

24. The adapter plate as set forth in claim 23, wherein the plugging means comprise holding holes for releasable insertion of pins on the base means.

25. The adapter plate as set forth in claim 23, wherein the plugging adaptations comprise holding pins for releasable insertion in plug receiving holes in the base means.

26. The adapter plate as set forth in claim 22, wherein the holding means is formed integrally on the adapter plate.

27. The adapter plate as set forth in claim 22, wherein the holding means comprises one or more burr fastener members for cooperation with at least one burr fastener element on the bag.

28. The adapter plate as set forth in claim 22, wherein the adapter plate is fashioned of plastic.

29. The adapter plate as set forth in claim 22, wherein the adapter plate has a larger area than the base means and in the attached state projects past the edge of the base means.
